(19) United States
(12) Patent Application Publication
(10) Pub. No.: US 2026/0301232 A1
(43) Pub. Date: Oct. 1, 2026

(54) ENCODING POINT DATA INDICATING A PLURALITY OF POINTS IN A THREE-DIMENSIONAL SPACE

(71) Applicant: Telefonaktiebolaget LM Ericsson (publ), Stockholm (SE)

(72) Inventors: Niclas SVENSSON, Stockholm (SE); Jacob STRÖM, Stockholm (SE); Rickard SJÖBERG, Stockholm (SE)

(73) Assignee: Telefonaktiebolaget LM Ericsson (publ), Stockholm (SE)

(21) Appl. No.: 19/475,620

(22) PCT Filed: Apr. 3, 2024
(86) PCT No.: PCT/EP2024/059093

§ 371 Date: Oct. 15, 2025

Related U.S. Application Data
(60) Provisional application No. 63/459,778, filed on Apr. 17, 2023.

(51) Int. Cl. G06T 9/00; G06T 9/20

(52) U.S. Cl. CPC G06T 9/001; G06T 9/20

(57) ABSTRACT

There is provided a method of encoding point data that indicates a group of points in a three-dimensional (3D) space. The method comprises obtaining the point data and partitioning the group of points into a plurality of blocks. The plurality of blocks includes a first block, and further wherein the first block includes a first point. The method further comprises calculating a comparison value based on a number of points included in the first block and/or distances between points included in the first block and determining whether a distance between the first point and an edge of the first block is less than the comparison value. The method further comprises, based on the determination, encoding the point data.

### TECHNICAL FIELD

Disclosed are embodiments related to encoding point data indicating a plurality of points in a three-dimensional (3D) space.

### BACKGROUND

Today 3D reconstruction of a space and/or an object is widely used in various fields. For example, for home renovation, a camera capable of capturing a 360-degree view may be used to capture multiple images of a kitchen that is to be renovated, and the kitchen may be reconstructed in a 3D virtual space using the captured multiple images. The generated 3D reconstruction of the kitchen can be displayed on a screen, and a user may manipulate the displayed reconstruction in order to help the user to visualize how to renovate the kitchen. In a 3D virtual space, there are a plurality of 3D points identifying an object and/or a portion of the 3D virtual space. In this disclosure, the plurality of 3D points is also referred as a 3D point cloud.

A 3D point cloud is an unstructured set of coordinates of points in a 3D space, and is typically used to capture the geometry and the scale of a scene. Thus, the 3D point cloud may represent 3D structure(s) in the physical world). In addition to storing the set of point coordinates in a 3D space, a 3D point cloud can store additional information about the 3D points. This additional information is also called attributes. Typical attributes are color information, reflectance, normal vectors, etc.

Even though the embodiments of this disclosure are applicable to point clouds with attributes, for the purpose of simple explanation, the embodiments are explained in the light of geometry compression—compressing point coordinates of the point clouds without attributes. In one example of the geometry compression, coordinates of a set of 3D points

$$Ω = {( {X}_{k} , {Y}_{k} , {Z}_{k} )}_{k = 1}^{K}$$

may be compressed, where K is the number of points, Xₖ is the x-coordinate of a k-th 3D point, Yₖ is the y-coordinate of a k-th 3D point, and Zₖ is the z-coordinate of a k-th 3D point.

Typical point clouds range in size from a few kB to several GBs, which puts at stress any application requiring storage and/or transmission of such point clouds. Therefore, efficient point cloud compression solution is needed in all industrial applications relying on such point clouds.

Geometry based Point Cloud Compression (G-PCC) is the current Moving Picture Expert Group (MPEG) standard that targets the use case of static point clouds, as disclosed in Reference 1 cited at the end of this disclosure. It uses octree coding to compress the geometry of 3D points. In using this compression method, as shown in FIG. 1A, it is assumed that a coordinate of each 3D point included in the point clouds is quantized into an integer coordinate, and is contained within a volume 102 (e.g., a cube) having the dimension of D×D×D. The cube 102 may be segmented into 8 sub-cubes 112 each having the dimension of D/2× D/2× D/2. If a sub-cube 112 contains at least one 3D point, then the sub-cube 112 is segmented into 8 smaller sub-cubes 122 each having the dimension of D/4×D/4×D/4. Then if a smaller sub-cube 122 contains at least one 3D point, then the smaller sub-cube 122 may be segmented into 8 micro sub-cubes 132. This segmentation process can be repeated until a sub-cube of a predetermined size (e.g., D/16×D/16×D/16) containing a 3D point can be identified. On the other hand, if a sub-cube does not contain any 3D points, the segmentation process for this sub-cube branch may end.

The above process generates a tree structure—an octree shown in FIG. 1B—where each node can be represented using 8 bits and each bit indicates the occupancy status of one sub-cube. For example, the 8 bits 00010000 corresponding to the second level of nodes may indicate that a fourth sub-cube 112 contains a 3D point data, and the 8 bits 00000011 corresponding to the third level of nodes may indicate that each of seventh and eighth smaller sub-cubes 122 belonging to the fourth sub-cube 112 contains a 3D point. For lossy compression, octree partitioning may be stopped at a pre-determined level, thereby generating a sparser reconstruction, and the corresponding sequence of 8-bit words is entropy coded.

G-PCC also contains a module called trisoup, which is explained in Reference 1. The trisoup module was developed to favor surface point clouds, i.e., the point clouds that are dense enough to capture surface structures. Similar to octree G-PCC, this compression module (a.k.a., trisoup coding) uses the octree coding to partition a point cloud into nodes (i.e., blocks each having a width larger than 1). However, when using this module, the octree partitioning typically stops at a higher level in the tree, making the nodes larger. This level is pre-determined and set by the user/encoder. However, instead of setting a fixed depth, the user may set a trisoup node size (nodeSize=2ⁿ, n=2, . . . ), where each node size corresponds to a depth.

FIG. 2A illustrates how 3D points included in a trisoup node (a.k.a., a “node” or a “block”) can be encoded together. As shown in FIG. 2A, first, a point surface 202 on which 3D points 204 (the very small dots located on the surface 202) are located is determined. The point surface 202 may be a curved surface or a flat surface (depending on the distribution of the 3D points). Once the point surface 202 is determined, cross points (a.k.a., “vertex points” or just “vertex”) 212, 214, 216, and 218 at which the point surface 202 crosses the boundary of a trisoup node (the cube shown in FIG. 2A) are determined. Additionally, a center point 230 of the point surface 202 may be determined.

After determining the vertex points 212, 214, 216, and 218 and the center point 230 of the point surface 202, data indicating the vertex points 212, 214, 216, and 218, and the center point 230 is generated and transmitted to a decoding entity. Upon receiving the data, the decoding entity may be configured to reconstruct the point surface 202 using the data, and reconstruct the 3D points of the trisoup node using the reconstructed surface.

One way of reconstructing the point surface 202 at the decoding entity is illustrated in FIG. 2B. As shown in FIG. 2B, the point surface 202 may be reconstructed by finding a plurality of triangle areas 252, 254, 256, and 258 using the vertex points and the center point. For example, the triangle area 252 may be found by identifying the vertex points 216 and 218, and the center point 230, the triangle area 254 may be found by identifying the vertex points 214 and 216, and the center point 230, the triangle area 256 may be found by identifying the cross points 212 and 214, and the center point 230, and the triangle area 258 may be found by identifying the vertex points 212 and 218, and center point 230.

When decoding the point cloud, the surfaces of each block may be reconstructed by populating all positions for points (called voxels) that intersect the modelled triangles. Since the reconstructed point cloud will be quantized, the number of positions that could be occupied is fixed to integer positions. The purpose of this TRISOUP module is to encode the point cloud at a lower bit rate without losing much accuracy. Compared to octree G-PCC, the reconstructed point cloud will be denser when using trisoup, which typically favors the distortion metrics used in MPEG.

As discussed above, in encoding point data that indicates the 3D points 204, the vertex points 212, 214, 216, and/or 218, and/or the center point 230 may be used. As shown in FIGS. 2A and 2B, these points approximately define the point surface 202 where the 3D points 204 are disposed.

During the encoding, the vertex points and/or the center point may be determined by analyzing the 3D points 204. After determining the vertex points and/or the center point, the point data corresponding to the vertex points and/or the center point may be transmitted instead of transmitting point data corresponding to all of the 3D points 204. Then, during the decoding, these points may be used to reconstruct the point surface 202, thereby obtaining the original 3D points 204. Thus, it is important to find the correct vertex points as incorrect vertex points may result in incorrectly reconstructing the original 3D points 204.

One way to find the vertex points 212, 214, 216, and/or 218 is checking whether any one of the 3D points 204 is close enough to an edge of a block (e.g., the cubes shown in FIGS. 2A and 2B). If any one of the 3D points 204 is close enough to the edge, such point may be set to be a vertex point. To determine whether any one of the 3D points 204 is close enough to the edge to be used as a vertex point, a comparison value (e.g., a threshold value) may be used. More specifically, a distance between each one of the 3D points 204 and the edge of the block can be determined, and if the distance is less than the comparison value, the corresponding 3D point can be set as a vertex point.

### SUMMARY

In the current G-PCC, the comparison value is determined by the characteristics of an entire point cloud slice. Note that a slice is a partition of a point cloud that can be encoded independently of other slices of the point cloud. More specifically, in the current G-PCC, the comparison value is determined based on an estimation of a density of points included in a slice of the point cloud, and the density of the points in the slice is estimated based on an estimated average of distances between points in the point cloud slice. Because the density of points is determined based on a distance between the points, the density may be called as a one-dimensional (1D) density.

However, in case the comparison value is determined based on the characteristics of an entire slice of the point cloud, the comparison values for all nodes included in the same slice would be the same even though different nodes included in the same slice may have very different point densities. In practice this means that the current technique of determining the vertex points may exclude some points that should be determined as the vertex points and may include some points that should not be determined as the vertex points. Since the vertex points are used for reconstructing the point cloud during the decoding, incorrectly identifying the vertex points may result in a reduced quality of the reconstructed point cloud. Accordingly, in some embodiments of this disclosure, the comparison value is determined for each node based on the density of points included in the node.

More specifically, in one aspect of the embodiments of this disclosure, there is provided a method of encoding point data that indicates a group of points in a three-dimensional, 3D, space. The method comprises obtaining the point data; partitioning the group of points into a plurality of blocks, wherein the plurality of blocks includes a first block, and further wherein the first block includes a first point; calculating a comparison value based on a number of points included in the first block and/or distances between points included in the first block; determining whether a distance between the first point and an edge of the first block is less than the comparison value; and based on the determination, encoding the point data.

In a different aspect, there is provided a computer program comprising instructions which when executed by processing circuitry cause the processing circuitry to perform the method of at least one of the embodiments described above.

In a different aspect, there is provided a carrier containing the computer program of the above embodiment, wherein the carrier is one of an electronic signal, an optical signal, a radio signal, and a computer readable storage medium.

In a different aspect, there is provided an apparatus for encoding point data that indicates a group of points in a three-dimensional, 3D, space. The apparatus is configured to obtain the point data; partition the group of points into a plurality of blocks, wherein the plurality of blocks includes a first block, and further wherein the first block includes a first point; calculate a comparison value based on a number of points included in the first block and/or distances between points included in the first block; determine whether a distance between the first point and an edge of the first block is less than the comparison value; and based on the determination, encode the point data.

In a different aspect, there is provided an apparatus comprising a processing circuitry; and a memory, said memory containing instructions executable by said processing circuitry, whereby the apparatus is operative to perform the method of at least one of the embodiments described above.

As explained above, the existing solution only takes global slice characteristics into consideration when estimating a 1D point density metric, which determines the comparison value used for finding the vertex points. On the contrary, in some embodiments of this disclosure, a 1D density matric is determined for each node by taking node local characteristics into consideration. This means that a unique comparison value may be determined for each node. By taking node local characteristics into consideration when determining the comparison value for each node, the points that were incorrectly identified as the vertex points can be excluded from being the vertex points and/or the points that were incorrectly excluded from being the vertex points can be determined as the vertex points. This may result in more accurate reconstruction of the original point cloud.

The accompanying drawings, which are incorporated herein and form part of the specification, illustrate various embodiments.

### BRIEF DESCRIPTION OF THE DRAWINGS

FIGS. 1A and 1B illustrate an octree coding method.

FIGS. 2A and 2B illustrate a method of decoding point data.

FIG. 3 shows an exemplary scenario where embodiments of this disclosure can be applied.

FIG. 4A shows an apparatus according to some embodiments.

FIG. 4B shows an example of a virtual reality scene.

FIG. 5 shows a process according to some embodiments.

FIG. 6A shows a bounding box surrounding a 3D point cloud.

FIG. 6B shows a bounding box surrounding a 3D point cloud.

FIG. 7A shows a plurality of slices of a bounding box.

FIG. 7B shows a plurality of nodes included in each of a plurality of slices.

FIG. 8 shows a distance between a point and an edge of a node.

FIG. 9A shows a distribution of points in a node.

FIG. 9B shows a distribution of points in a node.

FIG. 10 shows different densities of points included in different nodes.

FIG. 11 shows a process according to some embodiments.

FIG. 12 shows an apparatus according to some embodiments.

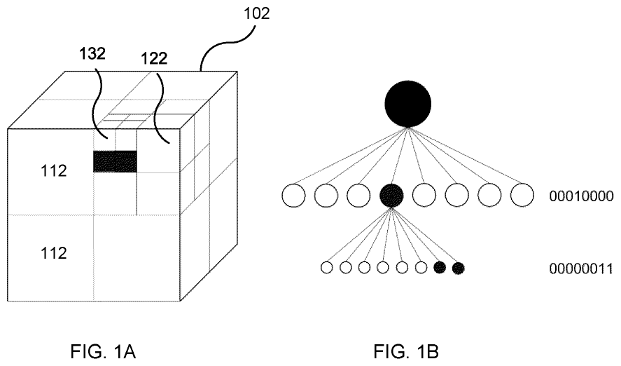

### DETAILED DESCRIPTION

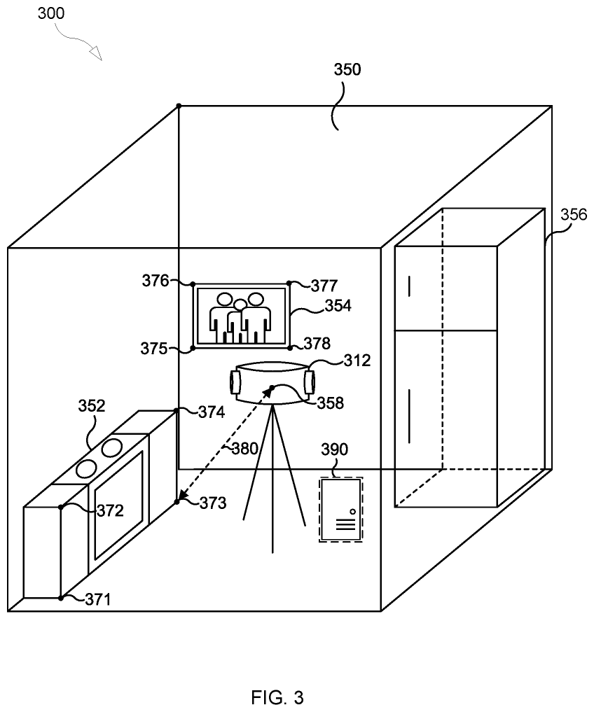

FIG. 3 shows an exemplary scenario 300 where some embodiments of this disclosure can be applied. In the scenario 300, a capturing device 312 is configured to capture a view of a kitchen 350. In the kitchen 350, an oven 352, a picture frame 354, and a refrigerator 356 are placed.

The capturing device 312 may include a camera and a Light Detection and Ranging (LiDAR) sensor. The camera is configured to capture a view of the kitchen 350. One example of the camera is a 360-degree camera—a camera that is capable of capturing a 360-degree view of a real-world environment.

The LiDAR sensor is configured to collect depth values of various real-world points (e.g., points 371-378) of the kitchen 350. Here, a depth value of a particular real-world point indicates a distance between a view point 358 of the capturing device 312 and the particular real-world point. For example, a depth value of a real-world point 373 indicates a distance 380 between the point 373 and the view point 358. One example of the view point 358 is a center point of the camera.

Once the view of the kitchen 350 is captured by the camera and depth values of the real-world points included in the view of the kitchen 350 are measured by the LiDAR sensor, the capturing device 312 may transmit the captured and/or measured data to a computing device 390 which is connected to the capturing device 312 (wirelessly or via a wired connection). After receiving the data, the computing device 390 may combine the data collected by the camera and the data collected by the LiDAR sensor, thereby generating 3D point data indicating a plurality of a 3D points.

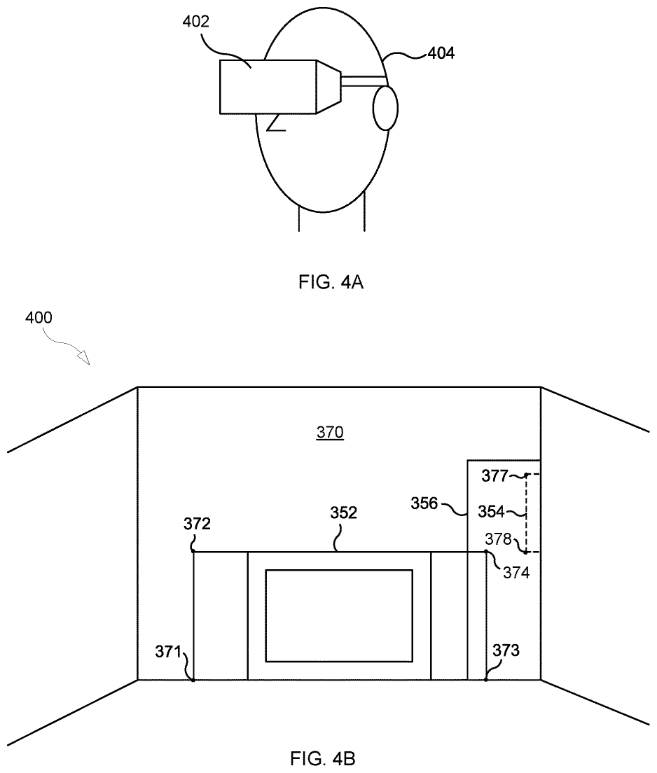

The 3D point data indicating the 3D points may be used to reconstruct the real-world environment captured by the capturing device 312. For example, the 3D point data indicating the 3D points may be used to generate an extended-reality (XR) (including a virtual-reality, a mixed-reality, or an augmented-reality) scene using an XR display 402 shown in FIG. 4A. View 400 shown in FIG. 4B is an example of the view user 404 sees via the XR display 402. The 3D point data of each 3D point may include a 3D coordinate of the 3D point and/or attributes such as color/luminance values of the 3D point.

The 3D point data indicating the plurality of 3D points generated by the computing device 390 may be stored in a storage (e.g., a memory included in the computing device 390). However, typical size of the 3D point data ranges from 1 GB to several GBs, and thus storing the 3D point data would require a substantial amount of storage space. Additionally, in some scenarios, there is a need to transmit the point data of the 3D points from one entity to another entity. For example, assume that an owner of a house wants to renovate the kitchen 350 but a kitchen designer is located far from the house. In such case, once a view of the kitchen 350 is captured and the point data identifying the 3D points of the kitchen 350 is generated by the computing device 390, the point data may be transmitted from the computing device 390 to the XR display device 402 such that the kitchen designer can see the reconstructed 3D view of the kitchen 350 via the XR display device 402. However, due to the large size of point data, transmitting the 3D point data would consume a substantial amount of data bandwidth. Therefore, there is a need to compress (i.e., encode) the 3D point data.

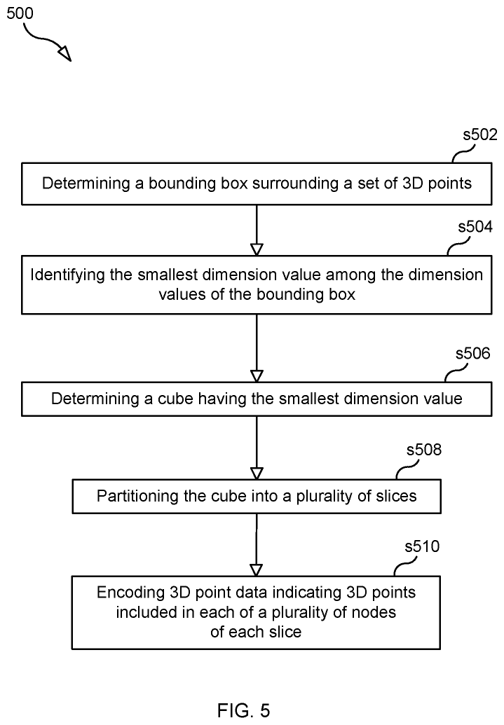

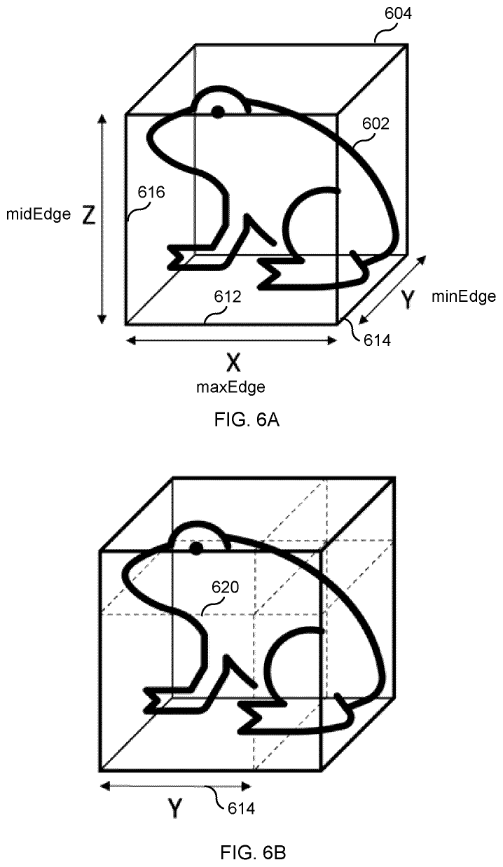

FIG. 5 shows a process 500 for compressing (i.e., encoding) 3D point data indicating a set of 3D points (a.k.a., a “3D point cloud” or “point cloud”) in the MPEG Geometry based Point Cloud Compression (G-PCC) Common Test Conditions (CTC). The process 500 may begin with step s502. The step s502 comprises determining a bounding box that surrounds the set of 3D points. For example, in FIG. 6A, the set of 3D points forms the shape of a frog 602, and via the step s502, a bounding box 604 surrounding the frog 602 is obtained. As shown in FIG. 6A, the bounding box 604 has a first dimension value 612 (e.g., the width in X direction), a second dimension value 614 (e.g., the depth in Y direction), and a third dimension value 616 (e.g., the height in Z direction).

After determining the bounding box 604, the process 500 may proceed to step s504. The step s504 comprises identifying the smallest dimension value among the first, second, and third dimension values 612, 614, and 616. In the example shown in FIG. 6A, the second dimension value 614 is the smallest.

After identifying the smallest dimension value, the process 500 may proceed to step s506. The step s506 comprises determining a cube having the smallest dimension value. In FIG. 6A, since the second dimension value 614 is the smallest, in the step s506, as shown in FIG. 6B, a cube 620 (the bottom left box among the four boxes bounded by dotted lines) having the second dimension value 614 is obtained.

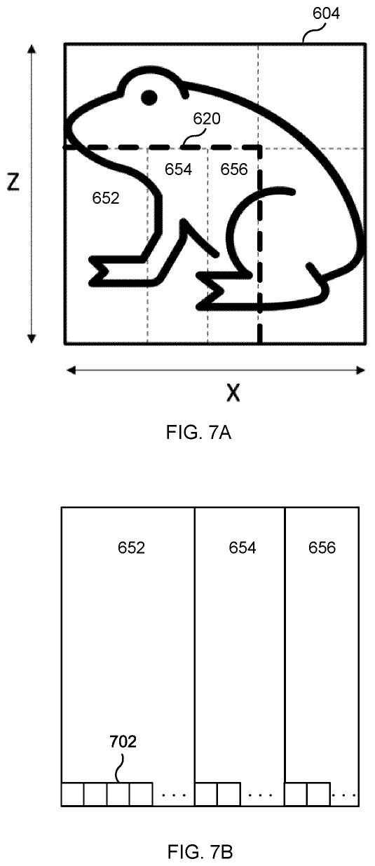

After determining the cube 620, the process 500 may proceed to step s508. The step s508 comprises partitioning the cube 620 into a plurality of slices. For example, in FIG. 7A, the cube 620 is partitioned into a plurality of slices 652, 654, and 656. As shown in FIG. 7B, each of the plurality of slices 652, 654, and 656 includes a plurality of nodes (a.k.a., a “trisoup node” or a “block”) 702. Each node 702 may be a cube or a rectangular cuboid.

After partitioning the cube 620 into the plurality of slices 652, 654, and 656, the process 500 may proceed to step s510. The step s510 comprises encoding 3D point data that indicates a plurality of 3D points included in each node 702 in each of the plurality of slices 652, 654, and 656. The 3D point data may be encoded into a bitstream or a coded representation of the point cloud.

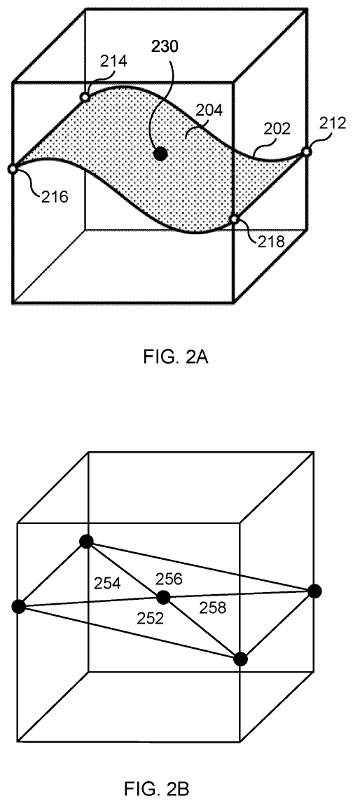

As explained above, the 3D point data indicating the 3D points included in each node 702 may be encoded using vertex points (e.g., 212, 214, 216, and 218 shown in FIG. 2A). The vertex points are the points at which a point surface (e.g., the point surface 202) where the 3D points are disposed intersects with the edges of the node.

As further explained above, one way of finding the vertex points is finding a point included in the point cloud (e.g., the 3D points 204 shown in FIG. 2A), which is close enough to any edge of the node. If a point is close enough to an edge of the node, then the point can be used as a vertex point. Here, the point that is evaluated as to whether it is close enough to the edge to be qualified as a vertex point is also called as a “vertex candidate point.” In some scenarios, there may be multiple points that are close enough to an edge of a node. In such scenario, a vertex point may be determined based on an average of the multiple points that are close enough to the edge of the node. The average may be calculated as the arithmetic mean, the geometric mean, any weighted mean, or other known similar calculations.

In determining whether a vertex candidate point is close enough to an edge of the node, a comparison value may be used. For example, a distance (e.g., the Euclidian distance) between a vertex candidate point and an edge of the node may be compared to a comparison value, and in case the distance is less than the comparison value, the point may be used as a vertex point.

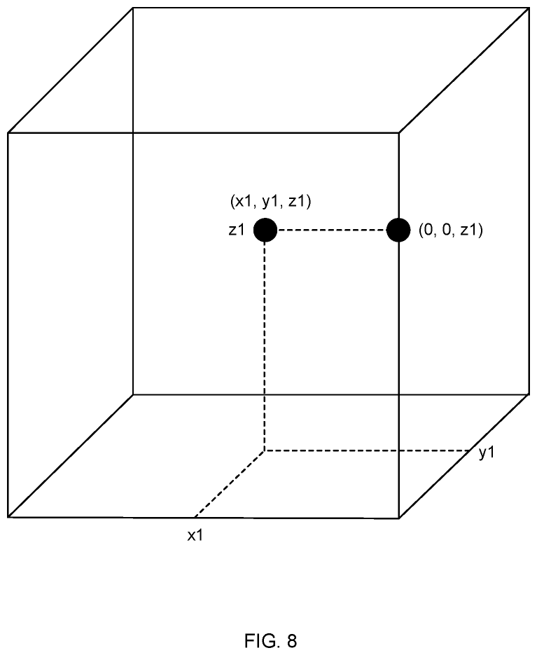

One way of determining the distance between a vertex candidate point and an edge of a node is using the coordinate of the vertex candidate point and the coordinate of a point in the edge (a.k.a., an “edge point”). For example, as shown in FIG. 8, in case the coordinate of a vertex candidate point is (x1, y1, z1) and the coordinate of an edge point is (0, 0, z1), then the distance may be calculated as \sqrt{(x1−0)²+(y1−0)²+(z1−z1)²=x1²+y1²}. Here, the edge point that is used for calculating the distance may be the point in the edge that is closest to the vertex candidate point. Note that in case a coordinate of each point is quantized to integer(s), the comparison value can also be an integer value (meaning that it doesn't have be a decimal value).

To be consistent with the current codec description and reference software of G-PCC, the terminologies used in Reference 2 may be used here. Thus, in this disclosure, the comparison value may also be referred as a distanceSearchEncoder value (“DSE value”).

### Determining a Comparison Value Based on the Density of Points Included in a Point Cloud or in a Slice of the Point Cloud

One way of determining the DSE value is by estimating a 1D density of points included in a point cloud or in a slice of the point cloud. The DSE value may be a decimal value or an integer value, and the DSE value that is an integer value may be called as an ES value.

As explained above, the comparison value (e.g., the ES value) may be determined based on an estimated 1D density of points included in the point cloud or in the slice, and the 1D density may be estimated based on an average of distances between points in the point cloud or in the slice. The average of the distances between the points in the point cloud or in the slice indicates how far two points belonging to the same point cloud or to the same slice are distanced from each other.

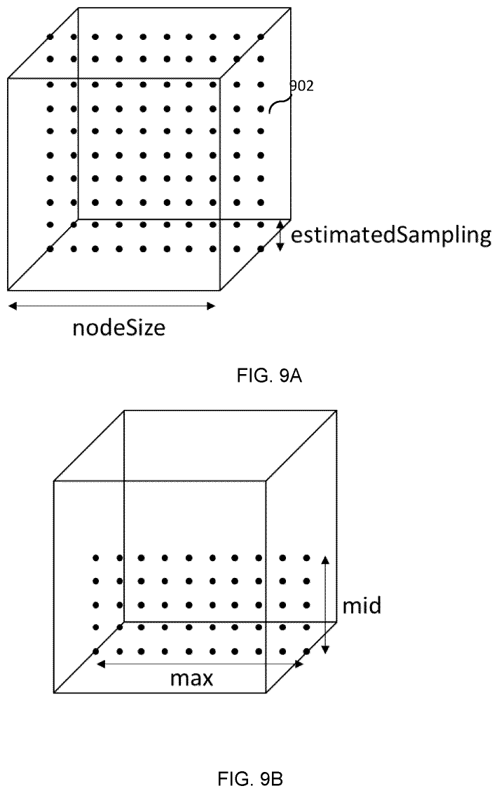

In case points included in a node span at least two entire dimensions (e.g., the width, the height, and/or the depth) of the node (e.g., see FIG. 9A), the number of points per node can be approximately determined as:

$$pointsPerNode = {( \frac{no deSize}{E S} )}^{2} . \qquad ( 1 )$$

where the pointsPerNode is the number of points per node and the nodeSize is the size of a node.

The equation (1) can be rewritten as:

$$E S = nodeSize \sqrt{\frac{1}{pointsPerNode}} . \qquad ( 2 )$$

The number of points per node can also be approximately determined as:

$$pointsPerNode = \frac{numPoints}{numNodes} . \qquad ( 3 )$$

Plugging the equation (3) into the equation (2) would result in the following equation (4).

$$E S = nodeSize \sqrt{\frac{numNodes}{numPoints}} , \qquad ( 4 )$$

where the numNodes is the number of nodes in an active slice or in an active point cloud, the numPoints is the number of points included in the active slice or in the active point cloud, and the nodeSize is the size of each node.

The ES value can be rounded to an integer, which is the DSE value. The rounding is performed by taking both the nodeSize (nodeSizeLog2) and a user set vertex position precision (vertexPrecisionLog2) into consideration as follows:

$$D S E = {2}^{m ax ( 0 , nodeSizeLog 2 - vertexPrecisionLog 2 - 2 )} - 1 + round ( E S + 0.1 ) . \qquad ( 1 )$$

Then DSE value may then be truncated to a value in between 1 and 8. Every point that is within the DSE value from an edge of a trisoup node contributes to the calculation of the position for that vertex for along the edge.

Using the calculated ES value, vertex points of each of the plurality nodes included in the same slice or in the same point cloud can be determined.

### Determining a Comparison Value Based on the Density of Points Included in a Node

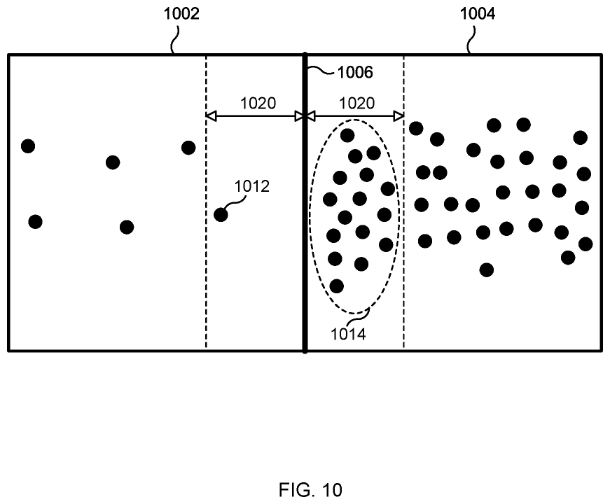

As explained above, using the same comparison value to find vertex points in all nodes belonging to the same slice or the same point cloud may result in finding incorrect vertex points. FIG. 10 illustrates this problem.

FIG. 10 shows a first node 1002 and a second node 1004, which belong to the same slice. Note that even though FIG. 10 shows only two nodes, more than two nodes can be included in the same slice.

As shown in FIG. 10, the density of points included in the first node 1002 and the density of points included in the second node 1004 are very different. This large difference in the densities may result in selecting incorrect vertex points in the first node 1002 and/or the second node 1004.

For example, in the first node 1002, since a distance between a point 1012 included in the first node 1002 and an edge 1006 of the first node 1002 is less than ES value 1020, the point 1012 is selected as a vertex point for the point cloud included in the first node 1002. On the contrary, in the second node 1004, since a distance between any one of a plurality of points 1014 and the edge 1006 of the second node 1004 is less than the ES value 1020, all of the points 1014 are selected as vertex points even though not all of them should be selected as the vertex points. This problem of incorrectly selecting some points as vertex points occurs because the same comparison value is used for finding the vertex points in the two different nodes having very different point densities.

Thus, according to some embodiments, the comparison value of an individual node is determined such that different comparison values are applied to different nodes having different point densities. More specifically, in some embodiments, the comparison value of an individual node is derived based on the density of points included in the node without considering the density of points that are outside of the node.

### Determining a Comparison Value Based on the Density of Points Included in a Node—ES1 Value

In some embodiments, instead of the ES value, the ES1 value below may be used as the comparison value.

$$E S 1 = nodeSize \sqrt{\frac{1}{numPointsNode}} . \qquad ( 6 )$$

where the nodeSize is a size of a node and the numPointsNode is the number of points included in the node. Note that this equation may be derived from the equation (4) as follows:

The equation (4) is for determining the comparison value for all nodes belonging to the same slice. If it is assumed that the slice has a single node, then the equation (4) becomes:

$$E S = nodeSize \sqrt{\frac{numNodes}{numPoints}} = nodeSize \sqrt{\frac{1}{numPointsNode}}$$

Because the number of nodes in the slice is now 1, and the number of points included in the slice is equal to the number of points included in the node.

The complexity of calculating the ES1 value may be expressed as O(1). The O(1) may indicate that the operation of calculating the ES1 value does not require an additional loop of analyzing the points.

### Determining a Comparison Value Based on the Density of Points Included in a Node—ES2 Value

In some scenarios, the point cloud (i.e., the 3D points) may not span the whole portion of the node. For example, in FIG. 9A, point cloud 902 spans across the whole portion of the node. For the point cloud 902, the equation (7) may be used for determining the comparison value. Note that the equation (7) can be rewritten as follows:

$$E S 1 = nodeSize \sqrt{\frac{1}{numPointsNode}} = \sqrt{\frac{nodeSize \times nodeSize}{numPointsNode}} \qquad ( 7 )$$

Here, nodeSize x nodeSize indicates a surface area of the node.

Contrary to FIG. 9A, in FIG. 9B, point cloud 912 spans across only a half of a dimension of the node. Thus, for the point cloud 902, the equation (7) that considers the whole surface area of the node (e.g., nodeSize×nodeSize) may not be appropriate. Therefore, according to some embodiments, in some embodiments, the size of the bounding box that bounds the point cloud 912 may be used for calculating the comparison value. More specifically, in some embodiments, instead of the ES1 value, the ES2 value below may be used as the comparison value.

$$E S 2 = \sqrt{\frac{max \times mid}{numPointsNode}} . \qquad ( 8 )$$

where the numPointsNode is the number of points in a current node, the max is the largest dimension of the bounding box, the mid is the second largest dimension of the bounding box.

The complexity of calculating the ES2 value may be expressed as O(numPointsNode). The O(numPointsNode) may indicate that the operation of calculating the ES2 value requires a full additional loop of analyzing the points over the set of points included in the node.

### Determining a Comparison Value Based on the Density of Points Included in a Node—ES3 Value

Instead of using the ES value, the ES1 value, and/or the ES2 value as the comparison value, in some embodiments, the ES3 value may be used as the comparison value. As explained above, in determining the density of points in a node using the ES1 value and the ES2 value, it was assumed that the points included in the node are uniformly distributed. But there may be a scenario where points included in one node are not uniformly distributed.

Therefore, according to some embodiments, the density of points included in a node may be calculated based on an average of distances between points in the node. More specifically, for each point included in the node, X number of points that are nearest to the point may be identified, and a distance between the point and each of the X points may be determined. Then an average of the determined distances is calculated. Then, an average of the calculated averages of the determined distances is calculated and used as the ES3 value. Here, the average may be calculated as the arithmetic mean, the geometric mean, any weighted mean, or other known similar calculation technique.

The complexity of calculating the ES3 value may be expressed as O(numPointsNode\hat{ }2). O(numPointsNode\hat{ }2) may indicate that the operation of calculating the ES3 value requires a nested for-loops of analyzing the points (e.g., finding the nearest neighbor of each point).

Determining the Comparison Value Based on the Density of Points Included in a Node and the Density of Points Included in a Slice that Includes the Node

In the embodiments described above, one of the ES value, the ES1 value, the ES2 value, and the ES3 value is selected and used as the comparison value regardless of what the values of ES, ES1, ES2, and/or ES3 are. However, in some embodiments, one of the ES value, the ES1 value, the ES2 value, and the ES3 value may be selected and used as the comparison value depending on the relationships among the values of ES, ES1, ES2, and/or ES3.

The logical sequence of selecting one of the ES value, the ES1 value, the ES2 value, and the ES3 value as the comparison value depending on the relationships among the values of ES, ES1, ES2, and/or ES3 is called a “decision tree” in this disclosure. One example of the decision tree is shown in the table below.

```
if (ES > 1):
  calculate ES1
  if (abs (ES − ES1) > m):
    calculate ES2
    if (abs (ES − ES2) > n):
      if (numPointsNode > 1):
        calculate ES3
        estimatedSampling = min (ES + 1, ES3)
      else:
        estimatedSampling = ES
    else:
      estimatedSampling = ES2
  else:
    estimatedSampling = ES //This value can also be ES1
else:
  estimatedSampling = ES
estimatedSampling = min(estimatedSampling, nodeSize/4)
```

In the above decision tree, the first if statement checks whether the ES value is larger than 1. If the ES value is not larger than 1, then it may mean that the ES value is small enough to represent the density of points in the node, and thus the ES value is selected and used as the comparison value.

On the other hand, if the ES value is larger than 1, it may mean that the ES value is too large, and thus, the ES value is not used as the comparison value. Then, the ES1 value is calculated.

After calculating the ES1 value, the second if statement checks whether a difference between the ES value and the ES1 value is larger than m. If the difference is not larger than m, it may mean that using the ES1 value as the comparison value is not worthwhile, and thus the ES value may be selected and used as the comparison value. Alternatively, if the difference is not larger than m, it may mean that it won't make much difference whether the ES value or the ES1 value is used as the comparison value, and thus the ES1 value may be selected and used as the comparison value.

On the other hand, if the difference between the ES value and the ES1 value is larger than m, the ES2 value may be calculated, and then the third if statement checks whether a difference between the ES value and the ES2 value is larger than n. If the difference is not larger than n, it may mean that using the ES2 value as the comparison value is not worthwhile, and thus the ES value may be selected and used as the comparison value. Alternatively, if the difference is not larger than m, it may mean that it won't make much difference whether the ES value or the ES2 value is used as the comparison value, and thus the ES2 value may be selected and used as the comparison value.

If the difference between the ES value and the ES2 value is larger than n, the fourth if statement checks whether a number of points included in the node is more than one. If the number of points included in the node is not more than one, it may mean that the ES3 value cannot be calculated, and thus the ES value may be selected and used as the comparison value.

On the other hand, if the number of points included in the node is more than one, a smaller one of (1) the ES value+1 and (2) the ES3 value may be selected and used as the comparison value. The rationale for choosing a smaller one of (1) and (2) is as follows: If a node includes few points (e.g., two points) scattered around in the node, the ES3 value may be very large because of the large distance between the points. If the ES3 value is set to be very high, then a point may be selected as a vertex point for various edges. This is not desirable. Accordingly in some embodiments, the ES3 value is limited to the ES value+1.”

Lastly, in the decision tree, the estimatedSampling value may be set such that it is not larger than the nodeSize/4.

In the decision tree shown in the table provided above, each of the ES1 value, the ES2 value, and the ES3 value is calculated after each of the if statements. However, in other embodiments, the ES1 value, the ES2 value, and the ES3 value may be calculated at any timing before they are used.

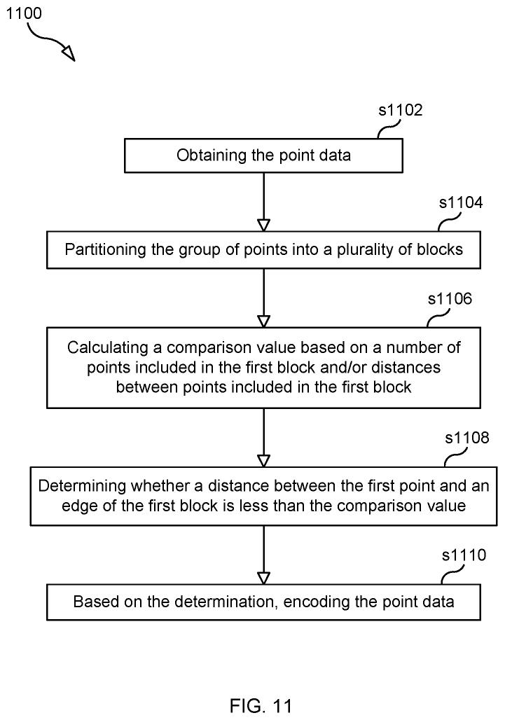

FIG. 11 shows a process 1100 of encoding point data that indicates a group of points in a three-dimensional, 3D, space. The process 1100 may begin with step s1102. The step s1102 comprises obtaining the point data. Step s1104 comprises partitioning the group of points into a plurality of blocks, wherein the plurality of blocks includes a first block, and further wherein the first block includes a first point. Step s1106 comprises calculating a comparison value based on a number of points included in the first block and/or distances between points included in the first block. Step s1108 comprises determining whether a distance between the first point and an edge of the first block is less than the comparison value. Step s1110 comprises, based on the determination, encoding the point data.

In some embodiments, the distance between the first point and the edge of the first block is determined to be less than the comparison value, the point data comprises a first portion indicating a plurality of points included in the first block, and the first portion of the point data is encoded using the first point.

In some embodiments, the first portion of the point data is encoded using two or more vertices included in the first block, said two or more vertices approximately define a surface on which the plurality of points of the first block are disposed, and the first point is one of said two or more vertices.

In some embodiments, the comparison value is calculated based on a candidate comparison value, ES1, and the ES1 is calculated based on a length of the first block and the number of points included in the first block.

In some embodiments, the

$$E S 1 = nodeSize \times \sqrt{\frac{1}{numPointsNode}} ,$$

where the nodeSize is the length of the first block, and the numPointsNode is the number of points included in the first block.

In some embodiments, the comparison value is calculated based on a candidate comparison value, ES2, and the ES2 is calculated based on a length of a first side of a boundary surrounding points included in the first block and the number of points included in the first block.

In some embodiments, the ES2 is calculated based on a length of a second side of the boundary surrounding the points included in the first block.

In some embodiments, the

$$E S 2 = nodeSize \times \sqrt{\frac{max \times mid}{numPointsNode}} ,$$

where the nodeSize is the length of the first block, the max is the length of the first side of the boundary, the mid is the length of the second side of the boundary, and the numPointsNode is the number of points included in the first block, and the length of the first side of the boundary is greater than the length of the second side of the boundary.

In some embodiments, the comparison value is calculated based on a candidate comparison value, ES3, and the ES3 is calculated by: (i) selecting a point included in the first block, (ii) determining a distance between the selected point and other points included in the first block, and (iii) calculating an average of the determined distances between the selected point and said other points included in the first block, and the ES3 is determined based on the average.

In some embodiments, the ES3 is calculated by repeating steps (i)-(iii) of embodiment A9 for each point included in the first block, and the ES3 is calculated based on an average of the averages calculated from performing the steps (i)-(iii) for each point included in the first block.

In some embodiments, the process 1100 comprises calculating a candidate comparison value, ES, based on a number of the plurality of blocks and a number of points included in the plurality of blocks; and determining that that ES is greater than a first predefined value, wherein the comparison value is calculated based on the number of points included in the first block and/or the distances between points included in the first block as a result of determining that that the ES is greater than a first predefined value.

In some embodiments, the

$$ES = nodeSize \times \sqrt{\frac{numNotes}{numPoints}} ,$$

where the nodeSize is the length of the first block, and the numPoints is the number of points included in a slice including the first block, and the numNodes is the number of nodes included in the slice.

In some embodiments, the process 1100 comprises calculating a difference between the ES and the ES1; and determining whether the difference between the ES and the ES1 is greater than a second predefined value, wherein the comparison value is calculated based on determining whether the difference between the ES and the ES1 is greater than the second predefined value.

In some embodiments, the process 1100 comprises determining that the difference between the ES and the ES1 is not greater than the second predefined value; as a result of determining that the difference between the ES and the ES1 is not greater than the second predefined value, calculating the comparison value based on the ES.

In some embodiments, the process 1100 comprises determining that the difference between the ES and the ES1 is greater than the second predefined value; and as a result of determining that the difference between the ES and the ES1 is greater than the second predefined value, determining whether a difference between the ES and the ES2 is greater than a third predefined value, wherein the comparison value is calculated based on determining whether the difference between the ES and the ES2 is greater than the third predefined value.

In some embodiments, the process 1100 comprises determining that the difference between the ES and the ES2 is not greater than the third predefined value; and as a result of determining that the difference between the ES and the ES2 is not greater than the third predefined value, calculating the comparison value based on the ES.

In some embodiments, the process 1100 comprises determining that the difference between the ES and the ES2 is greater than the third predefined value; and as a result of determining that the difference between the ES and the ES2 is greater than the third predefined value, determining whether the number of points included in the first block is more than 1, wherein the comparison value is calculated based on determining whether the number of points included in the first block is more than 1.

In some embodiments, the process 1100 comprises determining that the number of points included in the first block is not more than 1; and as a result of determining that the number of points included in the first block is not more than 1, calculating the comparison value based on the ES.

In some embodiments, determining that the number of points included in the first block is more than 1; and as a result of determining that the number of points included in the first block is more than 1, calculating the comparison value based on the ES and the ES3.

In some embodiments, the comparison value is calculated based on min (the ES+1, the ES3).

The method described in the following table is one detailed embodiment of this disclosure.

1. A method for encoding a point cloud comprising multiple points including at least a first
point and a second point, the method comprising:
partitioning the point cloud into a set of multiple nodes wherein each node is a 3D
block comprising edges and the set includes a first node comprising a first edge
determining a first value (ES) based on the number of nodes in the point cloud and
the number of points in the point cloud
determining a second value (ES1) based on the number of points in the first node
determining a first distance value between the first point and the first edge
determining a second distance value between the second point and the first edge
determining that the first point is intersecting the first edge based on the first value
(ES), the second value (ES1), and the first distance value
in response to determining that the first point is intersecting the first edge, deriving
a first intersection position on the first edge for the first point
determining that the second point is intersecting the first edge based on the first
value (ES), the second value (ES1), and the second distance value
in response to determining that the second point is intersecting the first edge,
deriving a second intersection position on the first edge for the second point
deriving a third position on the first edge from the first intersection position and the
second intersection position
encoding, into the bitstream, a third value representing the third position
2. The method of claim 1 wherein the third position is the only position on the first edge
that is encoded into the bitstream, and the third position represent a corner of a triangle
having three corners, wherein two of the corners are on different edges of the first node and
the third corner is inside the first node and not on any edge
3. The method of claim 2 wherein the third position is a trisoup vertex
4. The method of any previous claim wherein the determining of the second value is based
both on the number of points in the first node and a value representing the size of the first
node (details of eq 6)
5. The method of any claims 1-4 wherein the determining the second value comprises
deriving a size (ES2) of at least one side of a bounding box, wherein the bounding box is a
3D block that is smaller than the first node and contains all points in the first node
6. The method of any claims 1-4 wherein the determining the second value comprises
determining a set S of nearest neighboring points wherein any point that is included in the
set S is spatially closer to the first point than any point in the point cloud that is not
included in the set S. (ES3, partially)
7. The method of any previous claim comprising coding the set of multiple nodes into an
octree and encoding, into the bitstream, a representation of the octree

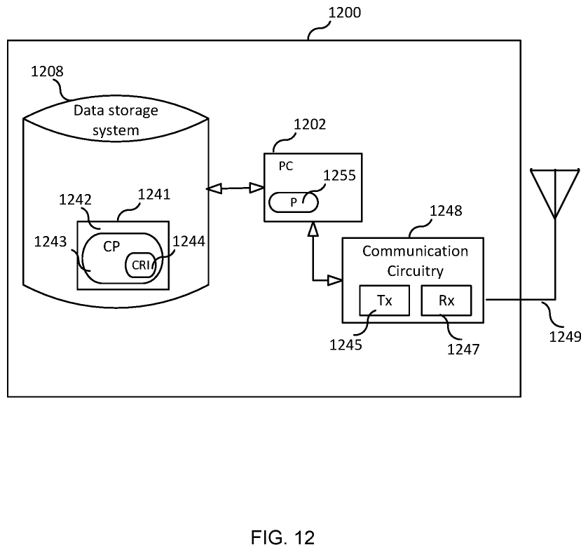

FIG. 12 is a block diagram of an apparatus 1200 for implementing an encoder, a decoder, or a component included in the encoder or the decoder, according to some embodiments. When apparatus 1200 implements a decoder, apparatus 1200 may be referred to as a “decoding apparatus 1200,” and when apparatus 1200 implements an encoder, apparatus 1200 may be referred to as an “encoding apparatus 1200.” As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 120 (e.g., an Internet Protocol (IP) network) to which network interface 1248 is connected (directly or indirectly) (e.g., network interface 1248 may be wirelessly connected to the network 120, in which case network interface 1248 is connected to an antenna arrangement); and a storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

### Summary of Embodiments

A1. A method (1100) of encoding point data that indicates a group of points in a three-dimensional, 3D, space, the method comprising:
obtaining (s1102) the point data;
partitioning (s1104) the group of points into a plurality of blocks, wherein the plurality of blocks includes a first block, and further wherein the first block includes a first point;
calculating (s1106) a comparison value based on a number of points included in the first block and/or distances between points included in the first block;
determining (s1108) whether a distance between the first point and an edge of the first block is less than the comparison value; and
based on the determination, encoding (s1110) the point data.

A2. The method of embodiment A1, wherein
the distance between the first point and the edge of the first block is determined to be less than the comparison value,
the point data comprises a first portion indicating a plurality of points included in the first block, and
the first portion of the point data is encoded using the first point.

A3. The method of embodiment A2, wherein
the first portion of the point data is encoded using at least three points included in the first block,
said at least three points approximately define a surface on which the plurality of points of the first block are disposed, and
the first point is one of said at least three points.

A4. The method of at least one of embodiments A1-A3, wherein
the comparison value is calculated based on a candidate comparison value, ES1, and
the ES1 is calculated based on a length of the first block and the number of points included in the first block.

A5. The method of embodiment A4, wherein the

$$E S = nodeSize \times \sqrt{\frac{1}{numPointsNode}} ,$$

where the nodeSize is the length of the first block, and the numPointsNode is the number of points included in the first block.

A6. The method of at least one of embodiments A1-A5, wherein
the comparison value is calculated based on a candidate comparison value, ES2, and
the ES2 is calculated based on a length of a first side of a boundary surrounding points included in the first block and the number of points included in the first block.

A7. The method of embodiment A6, wherein the ES2 is calculated based on a length of a second side of the boundary surrounding the points included in the first block.

A8. The method of embodiment A7, wherein the

$$E S 2 = nodeSize \times \sqrt{\frac{max \times mid}{numPointsNode}} ,$$

where the nodeSize is the length of the first block, the max is the length of the first side of the boundary, the mid is the length of the second side of the boundary, and the numPointsNode is the number of points included in the first block, and
the length of the first side of the boundary is greater than the length of the second side of the boundary.

A9. The method of at least one of embodiments A1-A8, wherein
the comparison value is calculated based on a candidate comparison value, ES3, and
the ES3 is calculated by:
   (i) selecting a point included in the first block;
   (ii) determining a distance between the selected point and other points included in the first block; and
   (iii) calculating an average of the determined distances between the selected point and said other points included in the first block, and
the ES3 is determined based on the average.

A10. The method of embodiment A9, wherein
the ES3 is calculated by repeating steps (i)-(iii) of embodiment A9 for each point included in the first block, and
the ES3 is calculated based on an average of the averages calculated from performing the steps (i)-(iii) for each point included in the first block.

A11. The method of at least one of embodiments A1-A10, comprising:
calculating a candidate comparison value, ES, based on a number of the plurality of blocks and a number of points included in the plurality of blocks; and
determining that that ES is greater than a first predefined value, wherein
the comparison value is calculated based on the number of points included in the first block and/or the distances between points included in the first block as a result of determining that that the ES is greater than a first predefined value.

A11a. The method of embodiment A11, wherein the

$$E S = nodeSize \times \sqrt{\frac{numNodes}{numPoints}} ,$$

where the nodeSize is the length of the first block, and the numPoints is the number of points included in a slice including the first block, and the numNodes is the number of nodes included in the slice.

A12. The method of embodiment A11 or A11a (when embodiment A11 or A11a depends on embodiment A4 and/or A5), comprising:
calculating a difference between the ES and the ES1; and
determining whether the difference between the ES and the ES1 is greater than a second predefined value, wherein
the comparison value is calculated based on determining whether the difference between the ES and the ES1 is greater than the second predefined value.

A13. The method of embodiment A12, comprising:
determining that the difference between the ES and the ES1 is not greater than the second predefined value; and
as a result of determining that the difference between the ES and the ES1 is not greater than the second predefined value, calculating the comparison value based on the ES.

A14. The method of embodiment A12 (when embodiment A11 depends on any of embodiments A6, A7, and A8), comprising:
determining that the difference between the ES and the ES1 is greater than the second predefined value; and
as a result of determining that the difference between the ES and the ES1 is greater than the second predefined value, determining whether a difference between the ES and the ES2 is greater than a third predefined value, wherein
the comparison value is calculated based on determining whether the difference between the ES and the ES2 is greater than the third predefined value.

A15. The method of embodiment A14, comprising:
determining that the difference between the ES and the ES2 is not greater than the third predefined value; and
as a result of determining that the difference between the ES and the ES2 is not greater than the third predefined value, calculating the comparison value based on the ES.

A16. The method of embodiment A14, comprising:
determining that the difference between the ES and the ES2 is greater than the third predefined value; and
as a result of determining that the difference between the ES and the ES2 is greater than the third predefined value, determining whether the number of points included in the first block is more than 1, wherein
the comparison value is calculated based on determining whether the number of points included in the first block is more than 1.

A17. The method of embodiment A16, comprising:
determining that the number of points included in the first block is not more than 1; and
as a result of determining that the number of points included in the first block is not more than 1, calculating the comparison value based on the ES.

A18. The method of embodiment A16, wherein
determining that the number of points included in the first block is more than 1; and
as a result of determining that the number of points included in the first block is more than 1, calculating the comparison value based on the ES and the ES3.

A19. The method of embodiment of A18, wherein the comparison value is calculated based on min (the ES+1, the ES3).

B1. A computer program (1200) comprising instructions (1244) which when executed by processing circuitry (1202) cause the processing circuitry to perform the method of at least one of embodiments A1-A19.

B2. A carrier containing the computer program of embodiment B2, wherein the carrier is one of an electronic signal, an optical signal, a radio signal, and a computer readable storage medium.

C1. An apparatus (1200) for encoding point data that indicates a group of points in a three-dimensional, 3D, space, the apparatus being configured to:
obtain (s1102) the point data;
partition (s1104) the group of points into a plurality of blocks, wherein the plurality of blocks includes a first block, and further wherein the first block includes a first point;
calculate (s1106) a comparison value based on a number of points included in the first block and/or distances between points included in the first block;
determine (s1108) whether a distance between the first point and an edge of the first block is less than the comparison value; and
based on the determination, encode (s1110) the point data.

C2. The apparatus of embodiment C1, wherein the apparatus is further configured to perform the method of at least one of embodiments A2-A19.

D1. An apparatus (1200) comprising:
a processing circuitry (1202); and
a memory (1241), said memory containing instructions executable by said processing circuitry, whereby the apparatus is operative to perform the method of at least one of embodiments A1-A19.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

Reference List

| | |
|---|---|
| 1. | Graziosi, D., Nakagami, O., Kuma, S., Zaghetto, A., Suzuki, T. and Tabatabai, A., |
| | 2020. An overview of ongoing point cloud compression standardization activities: |
| | video-based (V-PCC) and geometry-based (G-PCC). APSIPA Transactions on |
| | Signal and Information Processing, 9(1). |
| 2. | WG 7, MPEG 3D Graphics Coding, 2021, G-PCC codec description. (not |
| | externally available) |

1. A method of encoding point data that indicates a group of points in a three-dimensional, 3D, space, the method comprising:
obtaining the point data;
partitioning the group of points into a plurality of blocks, wherein the plurality of blocks includes a first block, and further wherein the first block includes a first point;
calculating a comparison value based on a number of points included in the first block and/or distances between points included in the first block;
determining whether a distance between the first point and an edge of the first block is less than the comparison value; and
based on the determination, encoding the point data.

2-25. (canceled)

26. The method according to claim 1, wherein
the distance between the first point and the edge of the first block is determined to be less than the comparison value,
the point data comprises a first portion indicating a plurality of points included in the first block, and
the first portion of the point data is encoded using the first point.

27. The method according to claim 26, wherein
the first portion of the point data is encoded using two or more vertices included in the first block,
said two or more vertices approximately define a surface on which the plurality of points of the first block are disposed, and
the first point is one of said two or more vertices.

28. The method according to claim 1, wherein
the comparison value is calculated based on a candidate comparison value, ES1, and
the ES1 is calculated based on a length of the first block and the number of points included in the first block.

29. The method according to claim 1, wherein the
$$E S 1 = nodeSize \times \sqrt{\frac{1}{numPointsNode}} ,$$
where the nodeSize is the length of the first block, and the numPointsNode is the number of points included in the first block.

30. The method according to claim 1, wherein
the comparison value is calculated based on a candidate comparison value, ES2, and
the ES2 is calculated based on a length of a first side of a boundary surrounding points included in the first block and the number of points included in the first block.

31. The method according to claim 30, wherein the ES2 is calculated based on a length of a second side of the boundary surrounding the points included in the first block.

32. The method according to claim 31, wherein the
$$E S 2 = nodeSize \times \sqrt{\frac{max \times mid}{numPointsNode}} ,$$
where the nodeSize is the length of the first block, the max is the length of the first side of the boundary, the mid is the length of the second side of the boundary, and the numPointsNode is the number of points included in the first block, and
the length of the first side of the boundary is greater than the length of the second side of the boundary.

33. The method according to claim 1, wherein
the comparison value is calculated based on a candidate comparison value, ES3, and
the ES3 is calculated by:
(i) selecting a point included in the first block;
(ii) determining a distance between the selected point and other points included in the first block; and
(iii) calculating an average of the determined distances between the selected point and said other points included in the first block, and
the ES3 is determined based on the average.

34. The method of claim 33, wherein
the ES3 is calculated by repeating steps (i)-(iii) for each point included in the first block, and
the ES3 is calculated based on an average of the averages calculated from performing the steps (i)-(iii) for each point included in the first block.

35. The method according to claim 1, comprising:
calculating a candidate comparison value, ES, based on a number of the plurality of blocks and a number of points included in the plurality of blocks; and
determining that that ES is greater than a first predefined value, wherein
the comparison value is calculated based on the number of points included in the first block and/or the distances between points included in the first block as a result of determining that that the ES is greater than a first predefined value.

36. The method according to claim 35, wherein the
$$E S = nodeSize \times \sqrt{\frac{numNodes}{numPoints}} ,$$
where the nodeSize is the length of the first block, and the numPoints is the number of points included in a slice including the first block, and the numNodes is the number of nodes included in the slice.

37. The method according to claim 35, wherein, when the comparison value is calculated based on a candidate comparison value, ES1, and the ES1 is calculated based on a length of the first block and the number of points included in the first block, the method further comprising:
calculating a difference between the ES and the ES1; and
determining whether the difference between the ES and the ES1 is greater than a second predefined value, wherein
the comparison value is calculated based on determining whether the difference between the ES and the ES1 is greater than the second predefined value.

38. The method according to claim 37, comprising:
determining that the difference between the ES and the ES1 is not greater than the second predefined value; and
as a result of determining that the difference between the ES and the ES1 is not greater than the second predefined value, calculating the comparison value based on the ES.

39. The method according to claim 37, wherein, when the comparison value is calculated based on a candidate comparison value, ES2, and the ES2 is calculated based on a length of a first side of a boundary surrounding points included in the first block and the number of points included in the first block, the method further comprising:
determining that the difference between the ES and the ES1 is greater than the second predefined value; and
as a result of determining that the difference between the ES and the ES1 is greater than the second predefined value, determining whether a difference between the ES and the ES2 is greater than a third predefined value, wherein the comparison value is calculated based on determining whether the difference between the ES and the ES2 is greater than the third predefined value.

40. The method according to claim 39, comprising:
determining that the difference between the ES and the ES2 is not greater than the third predefined value; and
as a result of determining that the difference between the ES and the ES2 is not greater than the third predefined value, calculating the comparison value based on the ES.

41. The method according to claim 39, comprising:
determining that the difference between the ES and the ES2 is greater than the third predefined value; and
as a result of determining that the difference between the ES and the ES2 is greater than the third predefined value, determining whether the number of points included in the first block is more than 1, wherein the comparison value is calculated based on determining whether the number of points included in the first block is more than 1.

42. The method according to claim 41, comprising:
determining that the number of points included in the first block is not more than 1; and
as a result of determining that the number of points included in the first block is not more than 1, calculating the comparison value based on the ES.

43. The method according to claim 41, wherein
determining that the number of points included in the first block is more than 1; and
as a result of determining that the number of points included in the first block is more than 1, calculating the comparison value based on the ES and the ES3.

44. The method according to claim 43, wherein the comparison value is calculated based on min (the ES+1, the ES3).

45. A computer program product comprising a non-transitory computer readable medium storing a computer program comprising instructions, which when executed by processing circuitry, cause the processing circuitry to perform the method according to claim 1.

46. An apparatus for encoding point data that indicates a group of points in a three-dimensional, 3D, space, the apparatus comprising a processing circuitry and a memory, said memory containing instructions executable by said processing circuitry, whereby the apparatus is operative to:
obtain the point data;
partition the group of points into a plurality of blocks, wherein the plurality of blocks includes a first block, and further wherein the first block includes a first point;
calculate a comparison value based on a number of points included in the first block and/or distances between points included in the first block;
determine whether a distance between the first point and an edge of the first block is less than the comparison value; and
based on the determination, encode the point data.
